(19) United States
(12) Patent Application Publication
(10) Pub. No.: US 2013/0145309 A1
(43) Pub. Date: Jun. 6, 2013

(54) METHOD AND APPARATUS OF CONTROLLING DIVISION SCREEN INTERLOCKING DISPLAY USING DYNAMIC TOUCH INTERACTION

(71) Applicants: Sung Tae Cho, Hwaseong (KR); Yeon Ji Kim, Hwaseong (KR)

(72) Inventors: Sung Tae Cho, Hwaseong (KR); Yeon Ji Kim, Hwaseong (KR)

(73) Assignee: HYUNDAI MOTOR COMPANY, Seoul (KR)

(21) Appl. No.: 13/469,407

(22) Filed: May 11, 2012

(30) Foreign Application Priority Data
Dec. 6, 2011 (KR) 10-2011-0129587

(51) Int. Cl. G06F 3/048; G06F 3/041

(52) U.S. Cl. 715/784

(57) ABSTRACT

A method and apparatus of controlling a division screen interlocking display using dynamic touch interaction are provided. The method includes recognizing a screen scroll input of a first pattern input through a touch screen, moving contents for each screen section in a scroll direction when the screen scroll input of the first pattern is recognized, and controlling corresponding contents deviated from a corresponding screen section by scrolling to be automatically converted according to a display format of a screen section in which corresponding contents are moved and output to the screen section while moving the deviated contents to an adjacent screen section of the screen in the scroll direction.

### CROSS-REFERENCES TO RELATED APPLICATIONS

This application claims priority to Korean patent application No. 10-2011-0129587 filed on Dec. 6, 2011, the disclosure of which is hereby incorporated in its entirety by reference.

### BACKGROUND OF THE INVENTION

1. Field of the Invention

The present invention relates to technology of controlling a screen output in a mobile terminal including a touch screen, and more particularly, to a method and apparatus of controlling division screen interlocking display using dynamic touch interaction. In particular, the method and apparatus divides a screen into two or more sections (a first section to an N-th section) and allows a user to scroll display contents of a first section while remaining sections are interlocked in the same direction and moved to an adjacent section of the screen. The contents of the remaining sections can further be automatically converted and output according to display formats of the sections.

2. Description of the Related Art

With developments of technology, terminals/terminal devices are generally becoming more lightweight, thin, short, and compact in an external appearance, and their functions and uses have generally become more complicated.

For example, personal portable terminals have progressed to more complicated structures configured to perform broadcasting reception and various multimedia functions such as photographing, video recording, reproducing music and image files, and gaming according to a user's desire in addition to typical basic functions (e.g. as a communication device).

Thus, while the amount of information provided by the terminal gradually increases and becomes more diverse, the display apparatuses which display corresponding contents on screens become thinner and scaled down. As a result, contents to be displayed on the screens are further compressed and omitted due to the restricted sizes of the displays.

In mobile terminals which, as a basic prerequisite, must be convenient to carry, a body thereof is necessarily restricted in size and, thus, a display apparatus thereof also inevitably becomes smaller than the body.

Accordingly, with conventional terminals, when a user selects another content at a state in which any one of multiple contents may be selected by the user and lower information included in the selected content is displayed on a display unit, it is difficult for the user to select the other content, and a touch input process must be performed in a small screen several times to select and watch another content.

Accordingly, there is a need for the development of an apparatus and method that overcomes these disadvantages and provides increased functionality and usability.

### SUMMARY OF THE INVENTION

Various aspects of the present invention have been made in view of the above problems, and provide a method and apparatus for controlling a division screen interlocking display using dynamic touch interaction. In particular, the apparatus and method (a) divides a screen into two or more sections (a first section to an N-th section), which may have different display formats from each other, (b) allows a user to scroll display contents of the first section, preferably in a constant direction through touch input previously preset to move a display area, (c) causes contents of remaining sections to be interlocked in the same direction and to move to an adjacent section of the screen, and (d) automatically converts and outputs the contents of the remaining sections according to display formats of the sections. As such, the present apparatus and method are capable of outputting a plurality of contents on a screen having a restricted size.

According to an aspect of the present invention, an apparatus is provided for controlling division screen interlocking display using dynamic touch interaction in a mobile terminal including a touch screen. The apparatus may include: a memory configured to store contents to be output through a touch screen as data; a control unit configured to control the overall operation of the apparatus according to user input (i.e. touch input) through the touch screen and to control the contents to be output through the touch screen, wherein the contents to be output is divided and output in two or more screen section (a first to a N-th sections) having different display formats based on information stored in the memory; and a touch interaction module configured to analyze the touch input of a user through the touch screen and to recognize a scroll command for the contents output on a screen. When the scroll command is recognized through the touch interaction module, the control unit may control contents for sections displayed in the divided screen sections so as to move in a scroll direction. Further, when the scroll command is recognized, the control unit may also control contents deviated from the screen sections (e.g. contents which move between screen sections by scrolling and, thus, are not within the screen sections) by scrolling and controlling a corresponding content to be automatically converted, wherein the scrolling and controlling are preferably carried out simultaneously. In particular, the deviated contents may be automatically converted according to the display format of the section to which the contents are moved, and the converted contents may be output to the section in which the contents are moved.

The memory may be implemented with a screen display content storage unit configured to divide a plurality of contents to be output to the divided screen sections based on predetermined display formats according to corresponding sections in which the contents are to be displayed.

When contents which move between screen sections by scrolling are represented, the control unit may control the contents which move between the screen sections to be scrolled so that the contents which move between the screen sections are consecutively represented to the scroll direction from an opposite direction on the basis of contents previously output. As such, continuity is provided.

According to another aspect of the present invention, a method of controlling division screen interlocking display using dynamic interaction in controlling a screen of a mobile terminal which includes a memory configured to store contents to be output through a touch screen as data; and a control unit configured to control a screen of the touch screen into a plurality of screen sections, and to control the contents to be output to corresponding screen sections which are divided according to data stored in the memory and are in different display format, wherein the method may include: recognizing a screen scroll input of a first pattern that is input through thetouch screen; moving contents for each screen section in a scroll direction when the screen scroll input of the first pattern is recognized; and controlling corresponding contents deviated from a corresponding screen section by scrolling to be automatically converted according to a display format of a screen section in which corresponding contents has been moved and output while moving the deviated contents to an adjacent screen section of the screen in the scroll direction.

The contents output on the screen may be, for example, a menu list in which a plurality of items are arranged. Contents may be displayed on at least one of the divided sections in the form of a plurality of icons each having a size smaller than a predetermined ratio of the screen size of a, and contents may be displayed on any of the remaining screen sections in the form of at least one icon each having a size larger than the predetermined ratio of the screen size.

The contents output on the touch screen may be configured in any way, such as titles of subjects selected by a user, in addition to detailed information for the titles. The titles may be displayed on at least one of the divided sections, such as in the form of a plurality of icons, as “upper” representative or general information. The more detailed information may be output to at least one of the divided screen sections other than the screen section on which the titles are displayed as “lower” specific detailed information which may be viewed when a corresponding title is selected by a user (e.g. through a double touch or double click).

The screen scroll input of the first pattern may be executed by dragging or clicking on a touch point.

The method may further include dragging to any direction (i.e. left, right, up and down) while in an area on the “division line” (i.e. interface between divided screen sections) and controlling the division line to move by dragging.

Controlling the division line may include automatically sizing contents of divided screens as the divided screens increase or decrease in size. For example, when the division line is moved so that a screen section increases in size, contents in that screen section are magnified by a predetermined ratio of a moving distance of the division line, whereas, in a screen section reduced in size, the contents are reduced by the predetermined ratio.

Dragging and moving a division line may include automatically increasing and reducing sizes of contents displayed on screen sections at both sides of the division line, as well as an increase and reduction in the number of the contents displayed on the screen sections by the predetermined ratio of the moving distance.

Dragging and moving a division line may include arbitrarily overlapping one division line with another division line to integrate two or more screen sections into one screen section.

According to an exemplary embodiment of the present invention having the above-described configuration, a method and apparatus of controlling a division screen interlocking display using dynamic touch interaction, which divides a screen into two or more sections (a first section to an N-th section) having different display formats from each other, allows a user to scroll display contents of the first section in a constant direction through touch input previously preset to move a display area, causes contents of remaining sections to be interlocked in the same direction and to move to an adjacent section of the screen, and automatically converts and outputs the contents of the remaining sections according to the display formation of the sections. Therefore, a user can display and view detailed information of a desired content through a simple touch input while scrolling a screen without requiring a separate cumbersome key input such as double click. Further, an arrangement state and full contents can be recognized and viewed even with a small screen having a restricted size and the screen can be utilized more effectively.

The apparatus and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram illustrating a main configuration of a terminal including a division screen interlocking display control function using dynamic touch interaction according to an exemplary embodiment of the present invention.

FIG. 2 is a view illustrating an external appearance of a mobile terminal having the configuration of FIG. 1.

FIG. 3 is a view illustrating a user's apparatus operation and a screen output.

FIG. 4 is a flowchart illustrating operation of an apparatus having the configuration of FIG. 1.

FIG. 5 is a view illustrating a process of interlocking a division screen by screen scrolling according to an exemplary embodiment of the present invention.

FIG. 6 is a view illustrating moving of a screen section division line.

### DETAILED DESCRIPTION

Reference will now be made in detail to various embodiments of the present invention(s), examples of which are illustrated in the accompanying drawings and described below. Like reference numerals in the drawings denote like elements. When it is determined that detailed description of a configuration or a function in the related disclosure interrupts understandings of embodiments in description of the embodiments of the invention, the detailed description will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Suffixes “module” and “part” for components used in the following description are assigned or mixed for clarity and thus, these suffixes themselves do not have meaning or functions to distinguish each other.

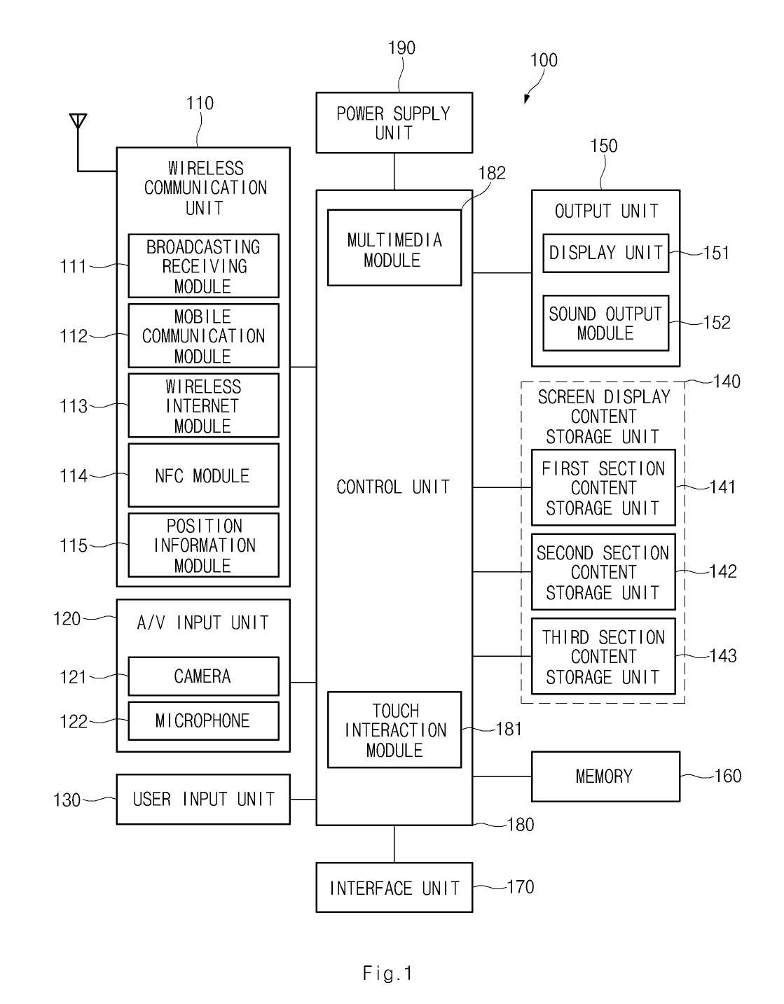

FIG. 1 is a block diagram illustrating a main configuration of a terminal having a division screen interlocking display control function using a dynamic touch interaction according to an exemplary embodiment of the present invention.

This embodiment of the present invention illustrates the case in which the terminal using the dynamic touch interaction is applied to a vehicle navigation system. It is to be understood that this embodiment illustrates only one implementation example, and the present invention can be implemented in various other ways. The terminal may be a terminal which is portable for user convenience, or it can be installed in another use apparatus. In addition, the terminal may be implemented in various types of apparatus such as a portable phone, a smart phone, a laptop computer, a digital broadcasting receiving terminal, a personal digital assistant (PDA), a portable multimedia player (PMP), a tablet computer, and the like.

As shown in FIG. 1, a mobile terminal 100 for a vehicle according to this embodiment includes a wireless communication unit 110, an audio/video (A/V) input unit 120, a user input unit 130, a screen display content storage unit 140, an output unit 150, a memory 160, an interface unit 170, a control unit 180, and a power supply unit 190.

The wireless communication unit 110 may include at least one module configured to enable wireless communication between the mobile terminal 100 and a wireless communication system, or between the mobile terminal 100 and a network provided in an area in which the mobile terminal 100 is disposed. That is, for example, the wireless communication unit 110 may include a broadcasting receiving module 111, a mobile communication module 112, a wireless Internet module, a near field communication (NFC) module 114, a position information module 115, and the like.

The broadcasting receiving module 111 may receive a broadcasting signal through an antenna, or may receive broadcasting-related information from an external broadcasting managing server through a separate broadcasting channel. The broadcasting channel may include, for example, a satellite channel and a terrestrial channel.

The broadcasting managing server may be a server configured to generate a broadcasting signal and/or broadcasting-related information and transmit the generated signal or information to a terminal or a server configured to receive a previously generated broadcasting signal and/or previously generated broadcast-related information and transmit the received signal or information to the terminal. In addition, the broadcasting signal may include a television broadcasting signal, a radio broadcasting signal, a data broadcasting signal such as traffic information (For example, Transport Protocol Expert Group (TPEG) information), and the like. Alternatively, the broadcasting signal may include a broadcasting signal in which a television broadcasting signal or a radio broadcasting signal is combined with a data broadcasting signal.

The broadcasting-related information may include broadcasting channel-related information, broadcasting program-related information, or broadcasting service provider-related information. The broadcasting-related information may be received by the mobile communication module 112 through a mobile communication network. The broadcasting-related information may be provided in an Internet protocol (IP) content format through the wireless Internet module 113.

The broadcasting-related information may be received using various digital broadcasting systems such as electronic program guide (EPG) of digital multimedia broadcasting (DMB), digital video broadcast-terrestrial (DVB-T), digital multimedia broadcasting-satellite (DMB-S), media forward link only (MediaFLO), digital video broadcast-handheld (DVB-H), or integrated services digital broadcast-terrestrial (ISDB-T). The broadcasting receiving module 111 may include the above-described digital broadcasting receiving apparatus. In some embodiments, the broadcasting receiving module 111 may be configured to be suitable for a broadcasting system having another format including an analog broadcasting signal, which is not illustrated in the above-described exemplary embodiment.

The broadcasting signal and/or the broadcasting-related information received through the broadcasting receiving module 111 may be stored in the memory 160.

The mobile communication module 112 transmits/receives a radio signal to/from at least one of a base station, an external terminal, and a server on a mobile communication network. The radio signal may include a voice call signal, video call signal, or data having various formats according to text/multimedia message transmission/reception.

The wireless Internet module 113 performs wireless Internet connection and may be embedded inside the mobile terminal 100 or connected to the outside of the mobile terminal 100.

Wireless Internet technology such as wireless local area network (WLAN) (Wi-Fi), wireless broadband (Wibro), world interoperability for microwave access (Wimax), high speed downlink packet access (HSDPA) may be used.

The NFC module 114 performs short-range communication and may use Bluetooth, radio frequency identification (RFID), infrared data association (IrDA), ultra wideband (UWB), ZigBee, or the like.

The position information module 115 acquires position information of the mobile terminal 100 and for example, typically uses a global positioning system (GPS) module. The control unit 180 may integrally calculate a GPS satellite signal received by the position information module 115 to calculate a current position thereof and display the calculated result on a map through a display unit 151 (which will be described later) or may perform guidance for a traveling direction, a traveling speed, or a path.

As shown in FIG. 1, the A/V input unit 120 receives image information and audio information and may include a camera 121, a microphone 122, and the like. The camera 121 generates a video frame for a still image, moving image, or the like obtained by an image sensor in a record mode of a “black box” for a vehicle. A “black box” is a device, system or object which is configured to be viewed in terms of its input, output and transfer characteristics without any knowledge of its internal workings, that is, its implementation is “opaque” (black). Thus, known systems and methods may be used to implement its structure. The generated image frame may be displayed on the display unit 151.

Alternatively, the video frame generated in the camera 121 may be stored in the memory 160 or transmitted to the outside through the wireless communication unit 110. The camera 121 may include two or more according to a use environment and may implement a multi-channel black box function to simultaneously capture images, for example, in two directions (forward and backward) or more.

The microphone 122 receives external sound information in a calling mode, a record mode, a voice recognition mode, or the like, converts the received external sound information into an electrical audio signal, and processes the converted audio signal. When the mobile terminal is in the calling mode, the converted audio signal may be processed into a signal to be transmitted by the mobile communication module 112 and the processed signal may be output through an antenna. A user may directly input a destination, a starting place, or the like for path search though her/his own voice. Various algorithms for removing noise generated in a process of receiving an external sound signal may be implemented in the microphone 122.

The user input unit 130 generates input information to control an overall operation of the mobile terminal according to the user's manipulation and may include a key pad, a dome switch, a touch pad (e.g. constant voltage/electrostatic type), a jog wheel, a jog switch, or the like.

The output unit 150 represents a result as a signal which is processed by the user's command through the mobile terminal 100 and can be recognized by the user by five senses through an agreed signal processor. The output unit 150 includes a display unit 151 and a sound output module 152 as typical output devices. The display unit 151 outputs data processed in the mobile terminal 100 on a screen as visual information. For example, when the mobile terminal 100 is in a navigation mode, the display unit 151 displays vehicle operation-related information such as a current position, a destination, or a path, a map, speed, a direction, and a distance instruction on a screen and provides a user interface related to the above display result. When the mobile terminal is in a black box mode or an imaging mode, the display unit 151 may provide a captured image or a user interface (or graphic user interface (GUI)).

The display unit 151 may include at least one of a liquid crystal display (LCD), a thin film transistor-LCD (TFT-CLD), an organic light-emitting diode (OLED), a flexible display, a three-dimensional (3D) display, or a dual display configured to display different images according to a viewing direction (for example, an output device in which a map is displayed when viewed in a driver's seat and a broadcasting screen is displayed when viewed in a passenger's seat).

Some of the various display apparatuses may be implemented in a transparent type or an optical transmissive type. A transparent OLED is typically used as the display device. A rear surface, that is, a rear side structure may also be implemented in an optical transmissive type which can view the output side therethrough. By the above-described structure, the user can view an object located in a rear side of a terminal body through an area which is occupied with the display unit 151 of the terminal body.

In addition, there may be two or more display units 151 according to various embodiments of the mobile terminal 100. For example, a plurality of display units may be arranged to be spaced apart or integral on one surface or may be arranged on different surfaces than each other.

When a sensor (hereinafter, referred to as a touch sensor) is configured to sense a touch operation of a display unit 151 and the user's touch operation has a layered structure (hereinafter, referred to as a “touch screen”), the display unit 151 may be used as an input device in addition to an output device. The touch sensor may have, for example, a touch film type, a touch sheet type, a touch pad type, or the like.

The touch sensor converts change in a pressure or a statistic capacitance applied to a specific portion into an electric signal and may be installed in the user input unit 130 or the output unit 150. The touch sensor may be configured to detect a position and an area to be touched as well as a pressure in touching.

When a touch input for the touch sensor is present, a signal corresponding to a contact is generated and then transmitted to a touch controller (not shown) and the touch controller processes the signal and transmits signal-processed data to the control unit 180. Therefore, the control unit 180 recognizes which area of the display panel is touched.

Hereinafter, for clarity, a behaviour in which a pointer is not in contact with the touch screen but, rather, is close to the touch screen so that the pointer is recognized to be positioned over the touch screen is referred to as “proximity touch”. A behaviour in which the pointer is substantially in contact with the touch screen is referred to as “contact touch”.

A position in which the proximity touch is performed on the touch screen by the pointer may be designated as a position corresponding to a point in which the pointer vertically extends and is close to the touch screen.

In addition, the touch screen may sense touch signals simultaneously applied to two points or more, and this is referred to as “multi-touch”.

The sound output module 152 may output audio data which is received from the wireless communication unit 110 in a multi-media file reproduction mode, a broadcasting reception mode, or the like or which is stored in the memory 160 as an audible sound. The sound output module 152 may output a sound for voice guidance (for example, a warning sound, an alarm sound, a path guidance voice or the like) related to functions performed in the mobile terminal 100 and may include typical components such as a receiver, a speaker, a buzzer or the like.

The memory 160 may, for example, store a program for data-processing and control of the control unit 180, may hold content materials such as a phone book, map information, audio information and video information, and may temporarily store data input from the user input unit 130 or output to through the output unit 150.

The memory 160 may also store use frequency for each of the above-described data (for example, use frequency for favourite destination and each multimedia file) as data. The memory 160 may also store data for vibrations and sounds of various patterns recognized when touch is input on the touch screen.

The memory 160 may include a storage medium having any one of a flash memory type, a hard disc type, a multimedia card micro type, a card type such as secure digit (SD) or extreme digit (XD), a random access memory (ROM) type, a static RAM (SRAM) type, a read only memory (ROM) type, a electrically erasable programmable ROM (EEPROM) type, a programmable ROM (PROM) type, a magnetic memory type, a magnetic disc type, an optical disc type.

The mobile terminal 100 may also be configured to be interlocked with a web storage which performs a function to store data on the Internet rather than in the memory 160.

The interface unit 170 serves as a path to all external apparatus connected to the mobile terminal 100. The interface unit 170 may be a device which receives data or may be supplied with power from the external apparatus, and may transmit the received data or the supplied power to each component of the mobile terminal 100. In addition, the interface unit 170 may be a device which transmits data processed in the mobile terminal 100 to the external apparatus.

The interface unit 170 may include a wired/wireless headset port, external charger port, a wired/wireless data port, a video input/output (I/O) port, an earphone port, and the like.

When the mobile terminal 100 is connected to an external cradle, the interface unit 170 may be a path in which power is supplied from the external cradle to the mobile terminal 100 or a path in which various kinds of command signals input from the external cradle by a user are transmitted to the mobile terminal 100. The various kinds of command signals and the power input from the external cradle may be used as a signal adapted to recognize whether or not the mobile terminal 100 is accurately mounted in the cradle.

The control unit 180 is a component configured to control the overall operation of the mobile terminal and may control data communication, path search, black box recording, and the like and data processing. The control unit 180 may include a multimedia module 181 configured to perform multimedia reproduction.

The control unit 180 may further include a touch interaction module 182 configured to interpret a signal input from the touch sensor according to an predetermined criterion and to convert the interpreted signal to a corresponding command.

A screen display content storage unit 140 is configured to divide a plurality of contents which is to be output through the display unit 151 based on predetermined formats according to sections in which the divided contents are to be displayed in the display unit 151 under control of the control unit 180. The screen display content storage unit 140 may include content storage units 141 to 143 allocated for the sections. Contents to be displayed in each section and display formats for the contents as data may be stored in each content storage unit 141 to 143 according to a predetermined control signal from the control unit 180.

Although the screen display content storage unit 140 may be configured separately from the memory 160 as shown in FIG. 1, the screen display content storage unit 140 may be embedded within the memory 160 if desired. Alternatively, without including a separate division storage module, the screen display content storage unit 140 may be implemented to selectively access content information stored in the memory 160, convert the content information, and output the conversion result on each section of a display screen by the control unit 180.

In addition, the multimedia module 181 and the touch interaction module 182 are not necessarily embedded within the control unit 180 and may be implemented separately from the control unit 180.

The power supply unit 190 supplies operation power to components of the apparatus according to control of the control unit 180.

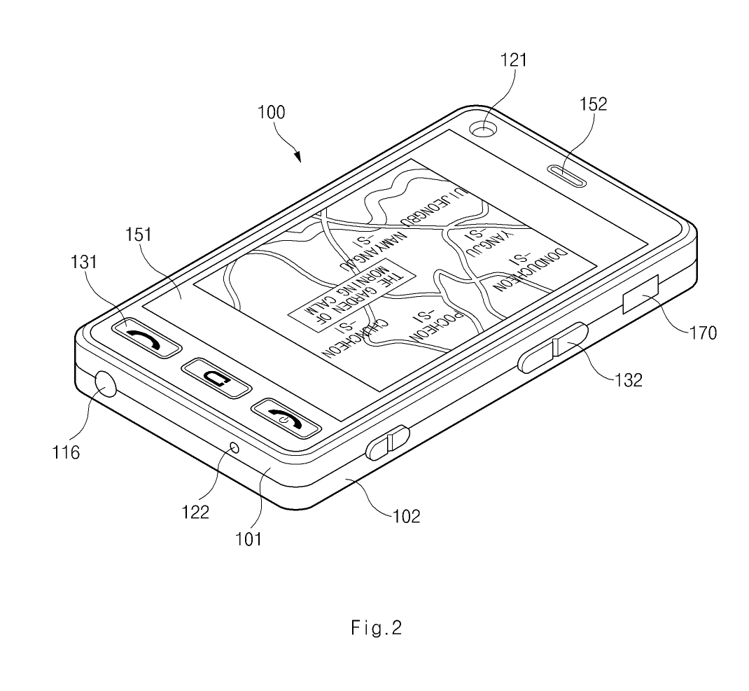

FIG. 2 is a view illustrating an external appearance of the mobile terminal 100 having the configuration of FIG. 1. As illustrated in FIG. 2, the mobile terminal includes a bar type body, but the exemplary embodiment may be applied to various structure in which two or more bodies are combined such as a slide type, a folder type, a swing type, a swivel type and the like.

The body of the mobile terminal include a case (a casing, a housing, a cover, or the like) 101 and 102 forming an outer shape. The case may be formed by injection-moulding a synthetic resin or fabricated of a metal material such as stainless steel (STS) or titanium (Ti).

The display unit 151, the audio output module 152, the camera 121, input buttons 131 and 132 of the user input unit 130, the microphone 122, the interface unit 170, and the like may be disposed in the body of the mobile terminal 100.

The display unit 151 typically occupies most of a main surface which is a front surface of a front case 101, and the locations of the various components can be in accordance with conventional designs. For example, the sound output module 152 and the camera 121 may be disposed on the front case 101 over the display unit 151. The input button 131 and the microphone 122 may be disposed on the front case 101 below the display unit 151 and the other input buttons 132 of the user input unit 130, the interface unit 170, and the like may be disposed on a side surface of the front case 101 and/or a rear surface. Of course, other positions for the various components may be used as desired.

The user input unit 130 is configured to input a command adapted to control an operation of the mobile terminal 100 from the user and may include a plurality of manipulation units. The manipulation units are collectively called a manipulation unit, and any tactile manner which is manipulated by a user may be applied to the manipulation unit.

The contents input by the manipulation units may be variously set. For example, a first manipulation unit may receive commands such as start, end, scroll and the like, and a second manipulation unit may receive commands such as a level adjustment of a sound output from the sound output module 152 and commands such as conversion to a touch recognition mode of the display unit 151.

The display unit 151 may display various kinds of visual information and the information may be displayed in form of a character, figure, symbol, graphic, icon and the like.

The information is regularly arranged to be displayed in the form of a key pad, and the user selects and touches a desired character shape to input corresponding information or to select a function. Thus, it is referred to as a virtual keypad.

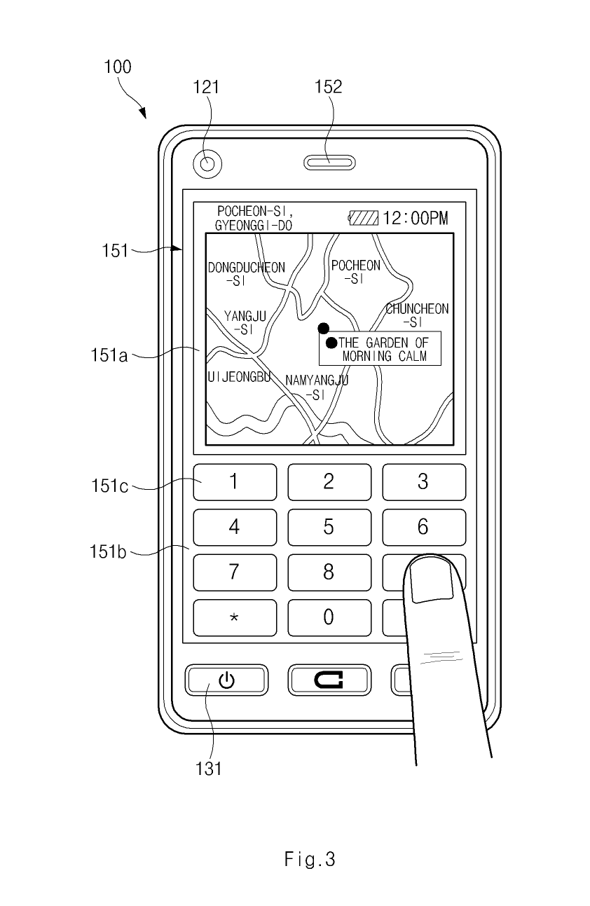

FIG. 3 illustrate a process of inputting information by a user through a touch input applied to a virtual key pad included in a front window of a mobile terminal. The display unit 151 may operate in a whole screen or may be being divided into a plurality of areas. When the display unit 151 is divided into a plurality of areas, the plurality of areas may be configured to operate to be interlocked with each other.

For example, as shown in FIG. 3, an output window 151a and an input window 151b may be disposed in an upper side and a lower side of the display unit 151, respectively, and a virtual key pad 151c in which figures are displayed to input an address/a street address, and the like may be disposed in the input window 151b. When the virtual key pad 151c is touched, a figure or the like corresponding to a point in which the virtual key pad is touched is displayed in one side area of the output window 151a.

In addition, a touch pad implemented with a layered structure in a display unit 151 may recognize a touch input (e.g. dragging) and may perform processes corresponding to the touch input.

The user may allow an object (for example, a cursor or a pointer positioned on an icon or the like) displayed on the display unit 151 to move by dragging a touch point while the user touches a surface of the touch pad on the display unit 151 using his/her finger. In addition, when the user allows his/her finger to move on the touch pad of the display unit 151, a moving path of the finger may be visually displayed on the display unit 151 and, thus, can make good use of editing an image displayed on the display unit 151. The display unit 151 shown in FIG. 3 may be implemented with a touch screen having the above-described function.

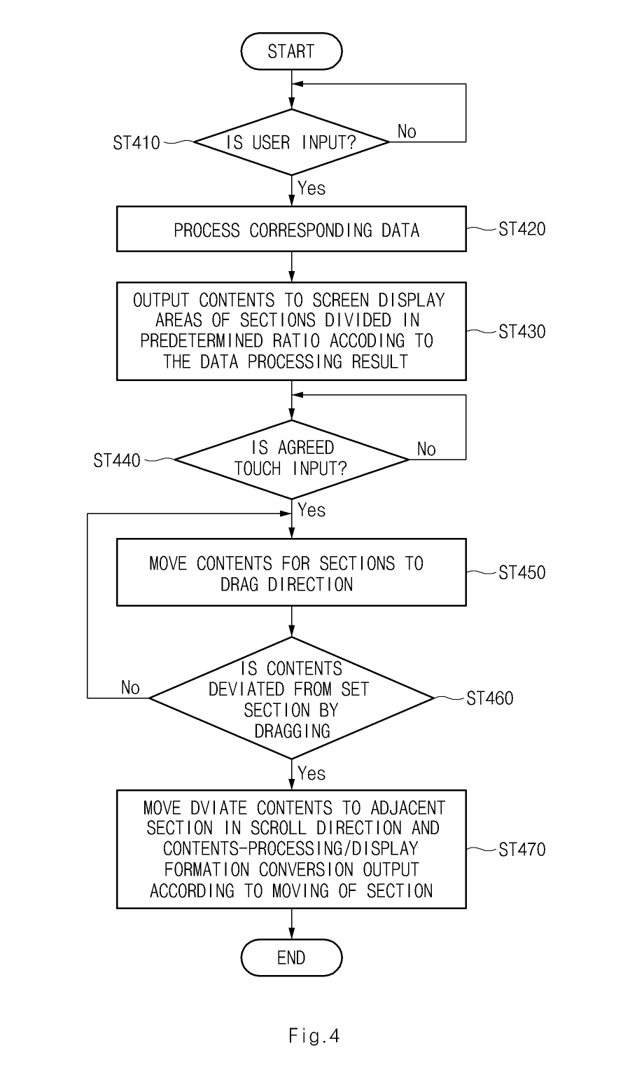

Subsequently, an operation of the apparatus having the above-described configuration will be described to a flowchart of FIG. 4.

An arrow type or finger type graphic adapted to indicate a specific object or select a menu in the display unit 151 is referred to as a pointer or a cursor. However, there may be many cases where the pointer mixedly denotes a finger, stylus pen, or the like for touch manipulation. Thus, to distinguish the pointer from the cursor in the specification, the graphic displayed on the display unit 151 denotes the cursor and physical means configured to perform touch, proximate touch, or gesture, such as a finger or a stylus pen, denotes the pointer.

FIG. 4 is a flowchart illustrating an operation of a mobile terminal including a function of controlling division screen interaction display according to an exemplary embodiment.

When a user selects a certain function button included in the user input unit 130 of the mobile terminal 100 (ST410), the control unit 180 reads data stored in the memory 160 and performs data processing corresponding to the user's function selection (ST420), classifies the processed data into a first section (1) and a second section (2) in which an upper representative item is displayed and a third section (3) in which lower detailed information is displayed, and outputs the classified result on a screen (ST430).

At this time, contents output in the first and second sections are to be output on the screen, for example, in the form of a list in which the contents have an icon type of a small size suitable to output a plurality of items on a screen having a limited size. The contents output in the section have a format in which specific detailed information is listed. The specific detailed information output in the third section may be set as contents indicating contents output when the user selects an item of the representative information displayed in the first section or the second section (e.g. through double click or double touch).

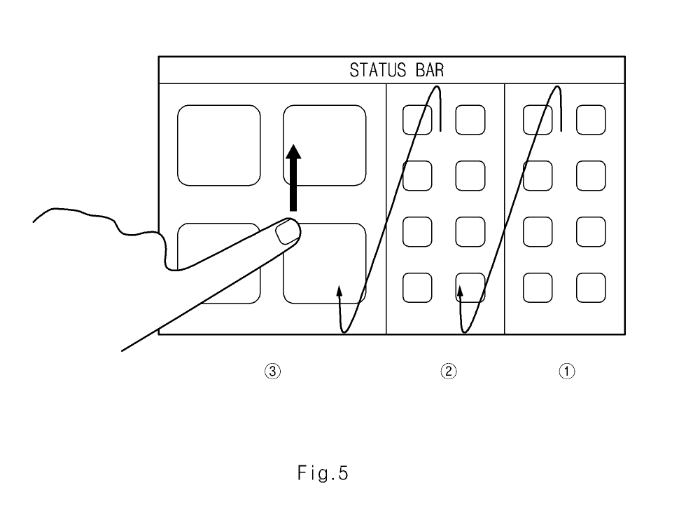

Subsequently, as shown in FIG. 5, when the user drags to execute a touch input on a screen upwardly by a predetermined distance, for example, a state in which the user touches the screen by a finger, the control unit 180 confirms whether or not the touch input by the user through the touch interaction module 182 is, for example, an agreed touch input such as an drag input (ST440). When it is determined that the touch input is the agreed touch input in step ST440, the control unit 180 allows the contents displayed in the sections (1), (2), and (3) of the screen to be scrolled in a drag input direction of the user, that is, in an upward direction (ST450).

Meanwhile, the touch input may be executed by dragging the touch point or by a flicking method.

At this time, the control unit 180 confirms whether or not contents are deviated from screen display areas for sections (1), (2) and (3) by scrolling according to the drag input of the user (ST460). When it is determined that the contents are deviated from the screen display area for each section in step ST460, the control unit 180 moves the contents deviated from the screen display area to a section adjacent to the scroll direction and simultaneously converts the contents according to an output format of the screen display area of the section in which the contents have been moved and outputs the converted contents (ST470).

As a result, the content deviated from a top end of the screen display area of the first section (1) by scrolling-up of the content is moved and displayed in a consecutive form as if the contents are connected to a bottom end of the second section (2). Similarly, contents positioned in the top end of the second section (2) are moved to a bottom end of the third section (3), the moved contents converted into detailed information output when the contents are double-clicked, and the converted detailed information is output.

In addition to the scroll-up direction, when the drag input in a scroll-down direction, a scroll-right direction, or a scroll-left direction is executed, the control unit 180 executes a process of moving each content in a drag direction through the above-described operation principle and the moved content is automatically converted corresponding to a display format of a corresponding section and the converted content is output.

That is, according to the exemplary embodiment, the screen is divided into two or more sections (a first section to a N-th section) having different display formats, and when a user scrolls contents displayed in the first section in a fixed direction to move to another display area through a preset touch input, contents of the remaining sections are interlocked in the same direction to move to a screen display area of adjacent sections, are automatically converted according to display formats of corresponding sections, and are then output to the adjacent section. Therefore, the division screen interlock display control apparatus using a dynamic touch interaction can be implemented.

The exemplary embodiment describes an example wherein contents displayed on the screen are classified into upper representative information and lower detailed information, such that upper representative information and lower detailed information are displayed on corresponding sections of the screen. However, it can also make good use of displaying a menu in which a plurality of items are listed on the screen.

That is, the menu is displayed on the screen so that items in the first and second sections are displayed in the form of a large number of small icons, while items in the third section are displayed in a form of a small number of large icons in which detailed information is included. Therefore, a more convenient item check and function selection environment can be provided to the user.

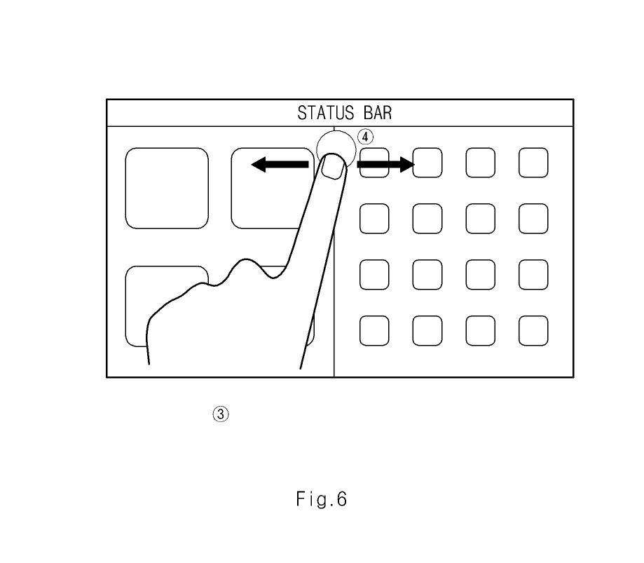

In addition, as shown in FIG. 6, the apparatus can be implemented so that the user can adjust sizes of screen display areas of adjacent sections and can combine the adjacent sections by laterally dragging the screen by touching on an area of the division line (4) which is an interface between the adjacent sections. For example, when the user drags the division line (4) left and a size of the third section (3) is reduced, sizes of items of the third sections (3) are reduced in association with reduction in the size of the third section (3), and a number of the items may also be increased. While the division line (4) moves right and the size of the third section (3) is increased, the sizes of the items in the third section (3) is increased in association with increase in the size of the third section (3) and a number of the items may also be decreased.

Thus, the user may move the division line (4) between the sections of the screen left and right so that the user can control arbitrarily the number of the items and the sizes of the items displayed in each section, and the user can further view a content of a desired item with zoom in or zoom-out at a desired size.

The present invention is not limited to the exemplary embodiment. The above-described exemplary embodiment may be modified without departing from the spirit and scope of the present invention. For example, the control unit 180 may be implemented such that the control unit 180 performs a process of, first, dividing content information to be output to screens for sections of a screen according to the sections and storing the divided content information in each storage area of the screen display content storage unit 140 allocated for each section, while the control unit 180 directly accesses information to be output to a corresponding section of a screen from the memory 160 and outputs the accessed information to the corresponding section without performing the process of dividing and storing the content information in the screen output process for each section (1), (2), and (3) in steps ST430 and ST470.

A division ratio of the touch screen and the kinds of information to be displayed in the respective divided section may be preset in mobile terminal fabrication and may be arbitrarily designated by a user.

All functions of the present invention may be implemented by adding a separate hardware. Alternatively, the functions may be implemented as a processor-recordable code in a program-recorded medium such as a read only memory (ROM), a random access memory (RAM), a compact disc-ROM (CD-ROM), a magnetic tape, a floppy disc, or an optical data storage device or a carrier wave type (for example, in case of transmission through Internet).

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling division screen interlocking display using dynamic touch interaction in a mobile terminal including a touch screen, the apparatus comprising:
a memory configured to store contents to be output through a touch screen as data;
a control unit configured to control an overall operation of the apparatus according to a touch input of a user through the touch screen, and to control the contents to be divided and output through the touch screen in two or more screen section (a first to a N-th sections) having different display formats based on information stored in the memory; and
a touch interaction module configured to analyze the touch input of the user through the touch screen and to recognize a scroll command for the contents output on the screen,
wherein when the scroll command is recognized through the touch interaction module, the control unit controls contents for sections displayed in the divided screen sections to move in a scroll direction, and controls contents deviated from the divided screen sections by scrolling and simultaneously controlling a corresponding content to be automatically converted according to a display format of a section in which the contents are moved and to output the converted contents to the section in which the contents have been moved.

2. The apparatus of claim 1, wherein the memory is implemented with a screen display content storage unit configured to divide a plurality of contents to be output to the divided screen sections based on predetermined display formats according to corresponding sections in which the contents are to be displayed.

3. The apparatus of claim 1, wherein, when contents which move between screen sections by scrolling are represented, the control unit controls the contents which move between the screen sections to be scrolled so that the contents which move between the screen sections are consecutively represented from the scroll direction to an opposite direction based on contents previously output, thereby providing continuity.

4. A method of controlling division screen interlocking display using dynamic interaction in controlling a screen of a mobile terminal including a memory configured to store contents to be output through a touch screen as data; and a control unit configured to control a touch screen into a plurality of screen sections and to conrol the contents to be output to corresponding screen sections divided according to the data stored in the memory in different display format, the method comprising:
recognizing a screen scroll input of a first pattern input through the touch screen;
moving contents for each screen section in a scroll direction when the screen scroll input of the first pattern is recognized; and
controlling corresponding contents deviated from an corresponding screen section by scrolling to be automatically converted according to a display format of a screen section in which corresponding contents aremoved and output to the screen section in which the corresponding contents have been moved while moving the deviated contents to an adjacent screen section in the scroll direction.

5. The method of claim 4, wherein the contents output on the screen are a menu list in which a plurality of items are arranged,
contents are displayed on at least one of the divided sections as a plurality of icons in which a size of each item thereof is smaller than a predetermined ratio of a size of the screen, and
contents are displayed on the remaining screen sections as at least one icon in which a size of each item thereof is larger than the predetermined ration of the size of the screen.

6. The method of claim 4, wherein the contents output on the screen are configured of titles of subjects selected by a user and detailed information for the titles,
the titles are displayed on at least one of the divided sections as a plurality of icons as upper representative information, and
the detailed information is output to at least one of the divided screen sections other than the screen section in which the titles are displayed as lower specific detailed information viewed when a corresponding title is selected through a double touch or a double click.

7. The method of claim 4, wherein the screen scroll input of the first pattern is executed by dragging or clicking on a touch point.

8. The method of claim 4, further comprising:
dragging to any one direction of left and right and up and down while touching an area on a division line which is an interface between divided screen sections; and
controlling the division line to move in the dragging direction.

9. The method of claim 8, wherein controlling the division line includes automatically sizing contents by moving the division line so that contents in a screen section which increases in sizes by the division line are magnified by a predetermined ratio of a moving distance of the division line, and contents in a screen section which decreases in size is reduced by the predetermined ratio.

10. The method of claim 8, wherein dragging and moving a division line includes automatically increasing and reducing sizes of contents displayed on screen sections at both sides of the division line, and the number of the contents displayed on the screen sections at both sides of the division line is increased and reduced by the predetermined ratio of the moving distance.

11. The method of claim 8, wherein dragging and moving a division line includes overlapping a division line with another division line to integrate two or more of the plurality of screen sections into one screen section.

12. A non-transitory computer readable medium containing program instructions executed by a processor or controller, the computer readable medium comprising:
program instructions that store contents in a memory to be output through a touch screen as data;
program instructions that control an overall operation of an apparatus according to a touch input of a user through the touch screen, and that control the contents to be divided and output through the touch screen in two or more screen section (a first to a N-th sections) having different display formats based on information stored in the memory; and
program instructions that analyze the touch input of the user through the touch screen and that recognize a scroll command for the contents output on the screen.
